(19) United States
(12) Patent Application Publication
(10) Pub. No.: US 2025/0075764 A1
(43) Pub. Date: Mar. 6, 2025

(54) FRICTION MATERIAL COMPOSITION AND ASSOCIATED BRAKE PAD

(71) Applicant: ITT Italia S.R.L., Milan (IT)

(72) Inventors: Margherita GILETTA, Barge (IT); Annamaria CANUTI, Barge (IT); Daniele MORERO, Barge (IT)

(73) Assignee: ITT Italia S.R.L., Milan (IT)

(21) Appl. No.: 18/554,227

(22) PCT Filed: Apr. 7, 2022
(86) PCT No.: PCT/IB2022/053272

§ 371 Date: Oct. 6, 2023

(30) Foreign Application Priority Data
Apr. 8, 2021 (IT) 102021000008807

(51) Int. Cl. F16D 69/02; F16D 65/092

(52) U.S. Cl. CPC F16D 69/026; F16D 65/092; F16D 2200/0052; F16D 2200/0065; F16D 2200/0073; F16D 2200/0082

(57) ABSTRACT

Friction material composition and associated brake pad for vehicles having a reduced or nil tendency to both stiction and creep groan, wherein the composition includes an organic binder; an inorganic filler; a lubricant; hard abrasives having a Mohs hardness of above 7 having exclusively a roundish shape, e.g. consisting in: Alumina, Corindone, Silicon carbide, Tungsten carbide, Zirconium carbide, Zirconium silicate, Boron nitride; soft abrasives having a Mohs hardness of below 7; carbon based materials; and a metal or mixture of metals except Cu, in an amount of less than 7% in volume calculated on the total volume of the composition; the ratio between the hard abrasive rounded and the carbon based materials being 1:3; the ratio between the hard abrasive rounded and the soft abrasives being 1:6; the ratio between the metal or mixture of metals and the carbon based materials being 1:6.

### CROSS-REFERENCE TO RELATED APPLICATIONS

This patent application claims priority from Italian patent application no. 102021000008807 filed on Apr. 8, 2021, the entire disclosure of which is incorporated herein by reference.

### TECHNICAL FIELD OF THE INVENTION

The present invention relates to a composition of friction material particularly suitable for the manufacture of friction layers/blocks for friction elements such as braking elements, for example brake pads or brake shoes for vehicles. The invention also relates to an associated brake pad made with this composition of friction material and particularly but not exclusively suitable for equipping a vehicle rear axle.

The composition of friction material of the present invention is free of asbestos and is, particularly but not exclusively, of the so-called “Low Steel” type, and has excellent characteristics with respect to the phenomena known as “Stiction” and “Creep Groan”, that is where the occurrence of such phenomena is limited or absent.

### STATE OF THE ART

The friction material compositions for producing brake pads can be classified in semi-metallic materials, which have more than 50% of ferrous metals (iron powder, steel fiber), low metallic materials or LS (low steel) with 5-35% of ferrous metals and Non-Asbestos Organic Materials (NAO) that substantially do not contain ferrous materials.

It is known that, particularly under harsh operating and/or environmental conditions, this may result, in use, in the “gluing” of one or more of the brake pads of a vehicle to the relative brake disc made of cast iron or steel. This is generally due to corrosive phenomena that affect the brake disc and that, during braking, result in the corrosion products combining with the friction material of the brake pad causing accidental adhesion of the brake pad to the brake disc, adhesion that is temporarily maintained even when the vehicle brake is deactivated. This phenomenon of adhesion is known by the English technical term “stiction”, a term that derives from the contraction and merging of the terms “static” and “friction”, i.e. the term “static friction”.

Obviously, the occurrence in use of a stiction or gluing phenomenon on a vehicle involves various drawbacks, such as jolts/straining during braking and subsequently the releasing of the brake, increased energy consumption and, in extreme cases, breakage of the friction material of the brake pad, which leads to vehicle breakdown and/or the necessity for the premature replacement of the brake pads. So, stiction phenomenon is well known in the brake pads field and also affect vehicles always running on paved roads, when exposed to damp whether condition.

Another phenomenon that occurs in brake pads, especially when made of LS friction materials, is the so-called “Creep groan”. This phenomenon consists of a low frequency chassis vibration in the vehicle, which is encountered with very low brake pad pressure and extremely low speeds, which give the driver a very uncomfortable feeling. It is the classic example of a self-excited braking vibration caused by the so-called “Stick-Slip” effect, i.e. by repeated “sticking” and subsequent slipping of the brake pad on the brake disc, or by the repeated transition between dynamic and static friction.

Various solutions are known in the art to try to reduce these phenomena, but they either do not solve completely the problem or present additional drawbacks.

EP0959262 discloses a disc brake pad capable of reducing creep groan using a composition containing a fibrous base material, except asbestos, a binder and a friction regulating agent, wherein the binder consists wholly or partially of a modified silicone resin and wherein, in combination, the friction material composition contains between 0.5 and 20% by volume of a zeolite as part of the agent regulating friction, the modified silicone resin being contained in the composition of friction material in the amount from 3% to 30% by volume of the total composition. The modified silicone resin is obtained by reacting an oil or a silicone rubber with a phenolic resin of the novolac type. This results in an expensive material and difficult to be produced.

US 2005/004258 describes a friction lining material which is free of copper but contains a considerable amount of stainless steel fibers. The filling material used in US 2005/004258 is graphite in an amount from 7 to 15% by volume.

WO 2011/131227 discloses a low-steel (LS) friction material for brake pads, which is substantially free of copper. The carbon component is contained in an amount of 36 to 51% by volume in the composition described therein. Low Steel friction lining compositions are designed for high pressure, high temperature applications and have good material properties at high speeds. However, known Low Steel (LS) friction lining material mixtures/compositions are disadvantageous in terms of braking comfort.

WO2019120648 discloses an hybrid friction lining material and brake pads made therefrom, wherein the positive properties of a steel low friction lining material (so-called Low Steel (LS) friction linings or friction lining material) and an asbestos-free organic friction lining material (so-called Non Asbestos Organic (NAO) friction linings or friction lining material) are attempted to be combined. In preferred embodiments, such hybrid friction material contains: 15 to 22%, in particular 17 to 20%, of at least one binder, 5 to 11% organic fibers or a mixture of organic fibers, 1 to 20%, in particular 8 to 14%, of at least one further organic compound, zero or from 8 to 16% of inorganic fibers or a mixture of inorganic fibers, 10 to 40% of at least one inorganic oxide, 6 to 12%, of at least one inorganic silicate, 13 to 15% of sulfur or at least one inorganic sulfur compound, 10 to 16% of carbon or at least one material consisting essentially of carbon, in particular selected from the group consisting of natural graphite, synthetic graphite, petroleum coke, desiccated petroleum coke, carbon black and any mixtures thereof, from 1 to 1.5% of at least one filler selected from the group of inorganic hydroxides, in particular calcium hydroxide, and zero up to 1% of at least one metal, in particular iron or iron alloys.

Such hybrid material however gives rise to a behavior which is a compromise in term of braking performances and comfort, which may be not optimal or less than optimal for many applications.

### Subject and Summary of the Invention

It is an object of the present invention to provide embodiments of a friction material designed to produce a friction block or layer, particularly but not exclusively for brake pads, wherein the friction material has a formulation that allow to decrease or eliminate the phenomena of both the stiction and creep groan by reducing the tendency of the friction block to stitch against a surface of a friction partner cooperating therewith.

In particular, the purpose of this disclosure is to provide embodiments of such friction material as an integral part of, or integrated in, a brake pad designed to cooperate in use with a brake disc made of steel or cast iron.

It is a further object of the invention to provide embodiments of a friction material having a composition aimed to obtain a braking behavior of the LS (Low Steel) friction composition type and which is free of copper and/or of copper alloys, except for impurities, but wherein the formulation is aimed to obtain a low tendency to stiction and a creep groan behavior comparable with, or even better than, those of the NAO (Non Asbestos Organic) friction compositions.

This disclosure therefore relates to embodiments of a friction material and of an associated brake pad of the so-called “copper-free” kind and formulated/made in such a way to decrease or eliminate the tendency of the friction block to stitch against a surface of a friction partner thereof, like a brake disc made of steel or cast iron, or an integral part of a clutch disc for vehicles or for any other application, as defined in the appended claims.

Here and in the following, the expression “copper-free” is to be understood to imply a content of copper and/or of copper containing materials, like copper alloys, of, or lower than, 0.5% mass (by weight).

The disclosure further relates to embodiments of a brake pad equipped with, or having as an integrated component thereof, such friction block or layer made of a friction material according to the invention.

The disclosure also relates to embodiments of a method for manufacturing brake pads for vehicles having a reduced or nil tendency to both stiction and creep groan.

In the embodiments of the present invention disclosed herein below, an asbestos free friction material composition is designed to be molded as a friction block or layer, preferably but not exclusively to equip a braking element like a brake pad or a brake shoe.

The asbestos free friction material composition comprises, as composing materials thereof, at least one organic binder, at least one inorganic filler, at least a lubricant, at least one hard abrasive, at least a soft abrasive, carbon based materials and, optionally, at least one metal or a mixture of metals.

Here and in the following, for hard abrasive must be understood inorganic substances having a Mohs hardness of 7 or more than 7, while for soft abrasive must be understood inorganic substances having a Mohs hardness of less than 7.

In the embodiment of the invention as per the present disclosure, the hard abrasives of a Mohs hardness of above 7 consist exclusively of hard abrasives having a roundish-shape.

Here and in the following, for “roundish-shape” must be understood the shape of a particle, e.g. of a substance in powder form, for which the ratio R/S between its Roundness and its Sphericity may be calculated, and has a value comprised between 0.6 and 0.8, including the lower and upper limit values of the above interval.

The Roundness and the Sphericity are quantities defined mathematically according to Krumbein and Sloss (1963), as e.g. described in the publication: “Oil Sand Characterization for Standalone Screen Design and Large-Scale Laboratory Testing for Thermal Operations”-Mahadi Mahmoudi et al.—SPE Thermal Well Integrity and Design Symposium-Banff, Alberta, Canada, 23-25 Nov. 2015.

Hard abrasives (i.e. having a Mohs hardness of more than 7) of roundish-shape suitable to be used according to the present invention may be chosen, preferably but not exclusively, in the group consisting of: Alumina, Corindone, Silicon carbide, Tungsten carbide, Zirconium carbide, Zirconium silicate, Boron nitride, any mixture thereof.

The carbon based materials which may be used in the embodiments according to this disclosure may be chosen, preferably but not exclusively, in the group consisting of: Graphite, Graphitized coke, Petroleum coke, Desulfurized petroleum coke, Carbon black, graphene, mixtures thereof.

The carbon based materials which may be used in the embodiments according to this disclosure may be contained in the friction material composition in an amount of less than 22% vol (“% vol” means “percentage in volume”) calculated on the total volume of the composition.

The at least one metal or a mixture of metals preferably does/do not consists of copper and/or of copper alloys, except for impurities (the content of copper is to be kept in any case equal to or lower than 0.5% by weight), and may be contained in the friction material composition in an amount of less than 7% in volume calculated on the total volume of the composition and may be chosen, preferably but not exclusively, in the group consisting of: Iron, Steel, stainless steel, Tin, Zinc, Metal alloys in powder or fiber form, Steel fibers, Stainless steel fibers.

The at least one lubricant may consist of a sulphide based lubricant, preferably but not exclusively chosen in the group consisting in the metal sulfides of Sn, Zn, Fe, Mo, and mixtures thereof; the sulphide based lubricant may be contained in the composition in an amount comprised between 6% vol and 18% vol calculated on the total volume of the composition.

The soft abrasive having a Mohs hardness of below 7 may be contained in the composition in an amount comprised between 26% vol and 38% vol calculated on the total volume of the composition and may be chosen, preferably but not exclusively, in the group consisting of: Magnesia, Cromite, Zirconia, Magnetite, Hematite, Quartz, Zinc oxides, Tin oxides, barium sulphate, silicate, fluoride, any mixture thereof.

The organic binder may consist in anyone of the following: Phenolic resins, Epoxy resins, siliconic resins, Modified phenolic resins, melamminic resins, polymmide resins and mixtures thereof; the organic binder may be present in the friction material composition in an amount comprised between 20% vol and 30% vol calculated on the total volume of the composition, alone or together with organic fibers. Suitable organic fibers may be chosen, preferably but not exclusively, in the group consisting of: Polyacrylic fibers, Polyaramid fibers, Aramid fibers, Cellulose fibers, any mixture thereof.

The content of organic fibers present in the composition is calculated as a fraction of the total content of the organic binder, i.e. as a part thereof.

The inorganic filler may be present in the composition in an amount comprised between 8% vol and 20% vol calculated on the total volume of the composition and may be chosen, preferably but not exclusively, in the group consisting of: Mineral fibers, Glass fibers, rockwool, phillosilicates (mica, vermiculite, talc), Titanates, inorganic hydroxides of Ca, Mg, K, any mixture thereof.

According to one aspect of the invention, the embodiments of the present disclosure may not include, except for impurities, any hard abrasives of a Mohs hardness of above 7 having an angular shape, as defined according to Krumbein and Sloss (1963), i.e. having particle size wherein the ratio R/S (Roundness/Sphericity) is lower than 0.6.

Moreover, the embodiments of the present disclosure may not include, except for impurities, any copper or copper alloy, either in form of powders or fibers.

The ratio between the content in volume of the rounded hard abrasive and the soft abrasives may be 1:5 and, in combination, the ratio between the content in volume of the lubricants with respect to that of the total of the abrasives (soft and hard, rounded) may be 1:4.

The ratio between the content in volume of the at least one hard abrasives of a Mohs hardness of above 7 having a roundish-shape and the content in volume of the carbon based materials may be 1:3.

The ratio between the content in volume of the at least one metal or mixture of metals and the carbon based materials may be 1:6 and, in combination, the ratio between the content in volume of the at least one metal or mixture of metals and the at least one hard abrasives of a Mohs hardness of above 7 having a roundish-shape may be 1:2.

A brake pad including a friction material block made of the friction material composition may be molded and cured in any suitable known manner, using the afore mentioned friction material composition.

In embodiments of a method for manufacturing brake pads for vehicles having a reduced or nil tendency to both stiction and creep groan it is comprised the step of preparing an asbestos free friction material composition as stated above, and the steps of molding said friction material composition in a friction material block or layer applied on a metallic support and of curing the friction material block or layer so obtained.

### BRIEF DESCRIPTION OF THE DRAWINGS

Preferred but not limiting embodiments will be now described in more detail with reference to a number of practical working examples of implementation thereof which are solely intended to disclose in a non-exhaustive and not limiting manner the feature which are part of the content of the present disclosure, and with reference to the figures of the attached drawings, in which:

FIG. 1 shows a SEM (Scanning Electron Microscope) microphotograph of an embodiment of the friction material composition according to the invention after molding and curing;

FIG. 2 shows schematically and in a brief manner the method of classification of the roundish or non-roundish shape of solid particles of irregular shape;

FIG. 3 shows a SEM microphotograph of an hard abrasive (Zirconium Silicate) having a roundish shape according to the definition given in the present disclosure;

FIG. 4 shows a SEM microphotograph of an hard abrasive (Silicon Carbide) not having a roundish shape according to the definition given in the present disclosure;

FIG. 5 shows a SEM microphotograph of a raw material (Vermiculite-phyllosilicate) used as a filler in embodiments of the present disclosure before being mixed with other composing materials of embodiments of the friction material of the present invention;

FIG. 6 shows a SEM microphotograph of the same material (Vermiculite-phyllosilicate) of FIG. 5 and used as a filler in embodiments of the present disclosure as it shows (see grey, elongated particles) in a friction material block after mixing, molding and curing;

FIG. 7 shows a graph reporting the results of a squadriga triaxle accelerometer test in: Amplitude (m/s²) Vs Time(s) relating to a friction material block made of an LS friction material according to a standard formulation;

FIG. 8 shows a graph reporting the results of the same squadriga accelerometer test in: Amplitude (m/s²) Vs Time(s) relating to a friction material block made of a friction material according to the invention; and

FIG. 9 shows a comparison between respective corresponding Fading sections of graphics showing the test result of the same AK-Master efficiency test performed upon two friction material blocks formed, respectively, in the LS friction material according to a standard formulation of FIG. 7 (graph on the left) and in the friction material according to the invention of FIG. 8 (graph on the right).

### DETAILED DESCRIPTION OF PREFERRED EMBODIMENTS OF THE INVENTION

Asbestos free friction material compositions designed to be formed in a friction block or layer, preferably but not exclusively to equip a braking element like a brake pad or a brake shoe, have been prepared and tested, operating with standard mixing techniques.

It has been prepared and tested, as a reference material, an asbestos free LS friction material composition formulation. Friction material compositions of standard formulated according to possible embodiments of the present invention but having for the remaining materials a formulation substantially corresponding to the formulation of the reference material have been also prepared and tested.

All the formulations of the asbestos free friction material composition (reference and inventive) prepared and tested comprise, as composing materials thereof, at least one organic binder, at least one inorganic filler, at least a lubricant, at least one hard abrasive having a Mohs hardness of above 7, at least a soft abrasive having a Mohs hardness of below 7, carbon based materials and, optionally, at least one metal or a mixture of metals.

The at least one lubricant may consist, preferably but not exclusively, of a sulphide based lubricant chosen in the group consisting in the metal sulfides of Sn, Zn, Fe, Mo, and mixtures thereof; in exemplary embodiments of the invention the sulphide based lubricant may be contained in the composition in an amount comprised between 6% vol and 18% vol calculated on the total volume of the composition.

The at least one soft abrasive having a Mohs hardness of below 7 may be contained in the composition, preferably but not exclusively, in an amount comprised between 26% vol and 38% vol calculated on the total volume of the composition.

The soft abrasive may be, preferably but not exclusively, chosen in the group consisting in: Magnesia, Cromite, Zirconia, Magnetite, Hematite, Quartz, Zinc oxides, Tin oxides, barium sulphate, silicate, fluoride, any mixture thereof.

The at least one organic binder may consist, preferably but not exclusively, of anyone of the following: Phenolic resins, Epoxy resins, siliconic resins, Modified phenolic resins, melamminic resins, polymmide resins and mixtures thereof.

The organic binder may be present in the composition in an amount comprised between 20% vol and 30% vol calculated on the total volume of the composition.

The friction material composition according to the invention may also comprise organic fibers, which may be chosen, preferably but not exclusively, in the group consisting in: Polyacrylic fibers, Polyaramid fibers, Aramid fibers, Cellulose fibers, any mixture thereof.

The organic fibers may be, preferably but not exclusively, contained in the friction material composition of the present disclosure as a part of the organic binder, since they may have the main object to increase the strength thereof under the operative working conditions of the brake pads/shoes which may be manufactured from the friction material compositions of the present disclosure.

Accordingly, the content of organic fibers present in the compositions of the present disclosure have been chosen as a fraction of the content of the organic binder, e.g. as a part of the total amount of from 20% vol to 30% vol calculated on the total volume of the composition thereof, depending on the mechanical properties to be implemented in the final friction material block molded from the raw composition and/or on the brake pad/shoe operative conditions, e.g. mechanical and thermal load.

The at least one inorganic filler may be present in the compositions of the present disclosure in an amount comprised between 8% vol and 20% vol calculated on the total volume of the composition; the least one inorganic filler is chosen, preferably but not exclusively, in the group consisting in: Mineral fibers, Glass fibers, rockwool, phillosilicates (mica, vermiculite, talc), Titanates, inorganic hydroxides of Ca, Mg, K, any mixture thereof.

The carbon based materials used in the friction material compositions of the present disclosure may be chosen, preferably but not exclusively, in the group consisting in: Graphite, Graphitized coke, Petroleum coke, Desulfurized petroleum coke, Carbon black, graphene, mixtures thereof.

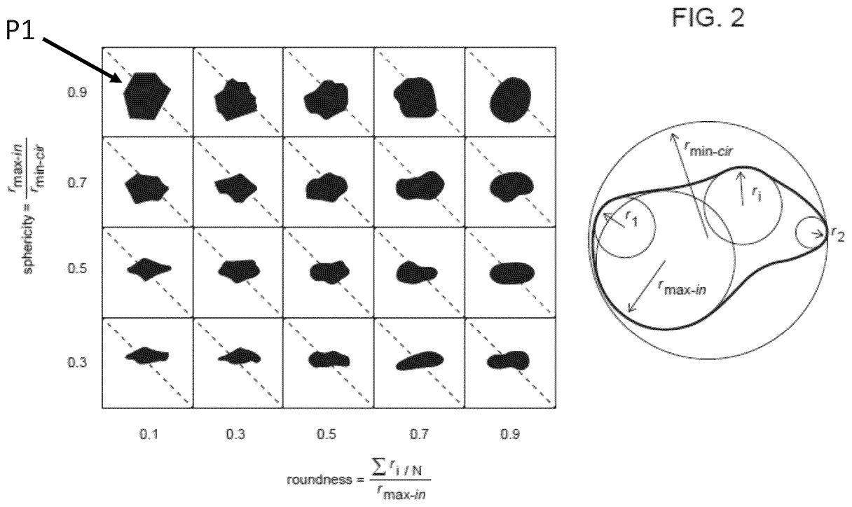

According to a first aspect of the present invention the hard abrasives of a Mohs hardness of above 7 which may be used in the friction material compositions of the present disclosure may consist, exclusively or almost exclusively, of roundish hard abrasives, i.e. of hard abrasives (i.e. having a Mohs hardness of above 7) formed by solid particles having a roundish-shape, where “roundish” is defined as stated below, with reference to FIG. 2.

Here and below, for “hard abrasives of a Mohs hardness of above 7 having a roundish-shape” is to be understood hard abrasives that may include, exclusively or almost exclusively abrasive particles having a ratio R/S (Roundness/Sphericity) in the interval:

$$0. 6 \leq R / S \leq 0.8$$

wherein R and S are calculated according to Krumbein and Sloss (1963), e.g. as referred to in the article “Oil Sand Characterization for Standalone Screen Design and Large-Scale Laboratory Testing for Thermal Operations”-Mahadi Mahmoudi et al.—SPE Thermal Well Integrity and Design Symposium-Banff, Alberta, Canada, 23-25 Nov. 2015.

Here and below, for “almost exclusively” is to be understood a quantity of particles which is 90% or close to 90% in volume of the total volume of the hard abrasive substance considered.

The calculation of the values R and S is to be carried out using the following equations (also reported in FIG. 2); the factors to be introduced in the formulas are shown in the non-limiting visual example given in the right side part of FIG. 2:

$$R = Roundness = \frac{\sum ri / N}{r max - i n} \qquad [ 1 ]$$

$$S = Sphericity = \frac{r max - i n}{r min - c i r} \qquad [ 2 ]$$

Namely, an irregular-shape particle may be schematized as shown in FIG. 2, right side; such particle may have some rounded edges, each of radius r₁, r₂, . . . rᵢ, as indicated in FIG. 2; the particle may be inscribed in a circle; the inscribing circle of minimum radius has a radius “r_{min-cir}”, as shown in FIG. 2; the rounded edge of maximum radius has a radius “rₘₐₓ₋ᵢₙ”; even if no rounded edges are found, “rₘₐₓ₋ᵢₙ” will be in this case the radius of the larger circle that may be inscribed within the particle boundary.

In the table shown in the left side of FIG. 2 the shape of the boundary of some “real” particles is visually schematized and the values of R and S that may be calculated as explained above are given. As one may see, even a particle identified as P1 with only sharp edges may have a high Sphericity (0.9), but it has (of course) a very low Roundness (0.1).

Accordingly, the ratio R/S can always be calculated and as it may be seen from the graphic table in FIG. 2, left side, the particles which appear to have a most smooth and rounded boundary are all within the interval given above:

$$0.6 \leq R / S \leq 0.8$$

According to the definition given above, the hard abrasives of a Mohs hardness of above 7 having a roundish-shape may be chosen, preferably but not exclusively, in the group consisting in: Alumina, Corindone, Silicon carbide, Tungsten carbide, Zirconium carbide, Zirconium silicate, Boron nitride, any mixture thereof.

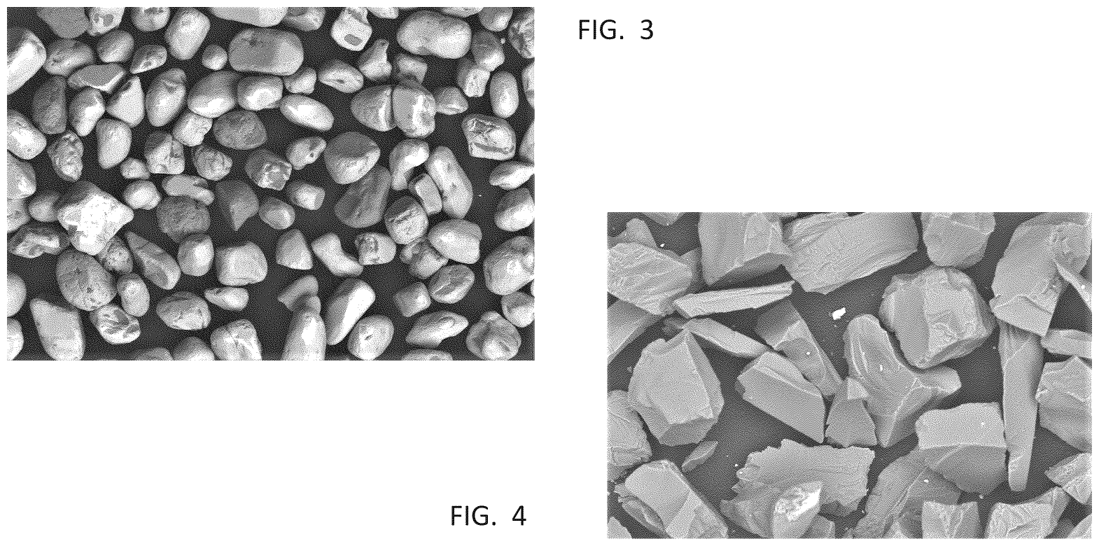

As a further examples of what is the visual aspect of a raw hard abrasive material which may be classified as “hard abrasives of roundish shape” is presented in FIG. 3 a SEM micrography of Zirconium silicate. The aspect to this material of FIG. 3 is to be compared with the aspect of the material shown in FIG. 4, which is a micrography having the same magnification of FIG. 3 of an hard abrasive of Mohs hardness of above 7 but not having a roundish shape, namely, in the example shown, silicon carbide.

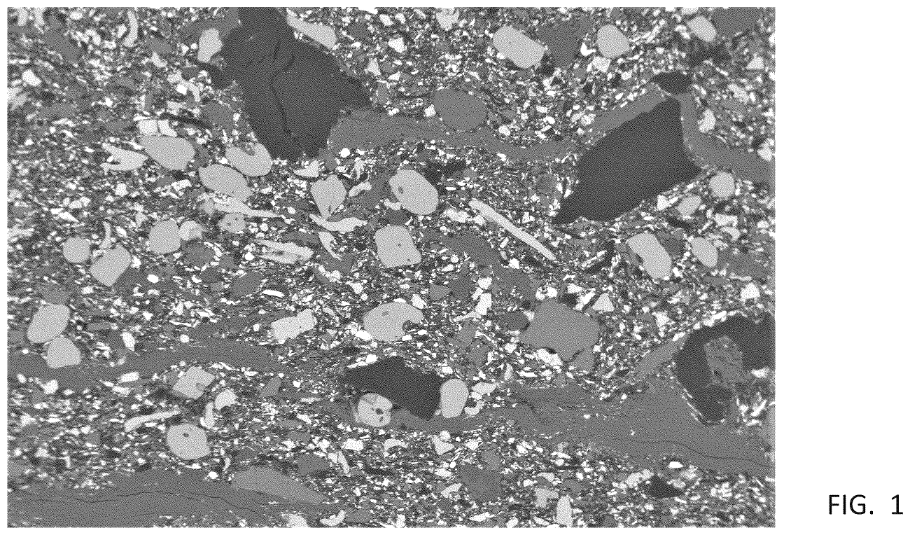

FIG. 1 shows the aspect assumed by the raw material of FIG. 3 in a friction material composition according to the invention after curing, i.e. in a friction block of friction material ready to be applied (or already applied) to a metallic support to form a brake pad. As it is clearly shown, the large roundish particles dispersed in the matrix of cured friction material are those of Zirconium silicate, i.e. those of the hard abrasive of roundish shape having a Mohs hardness of above 7, as they may be identified by spectrum micrography analysis.

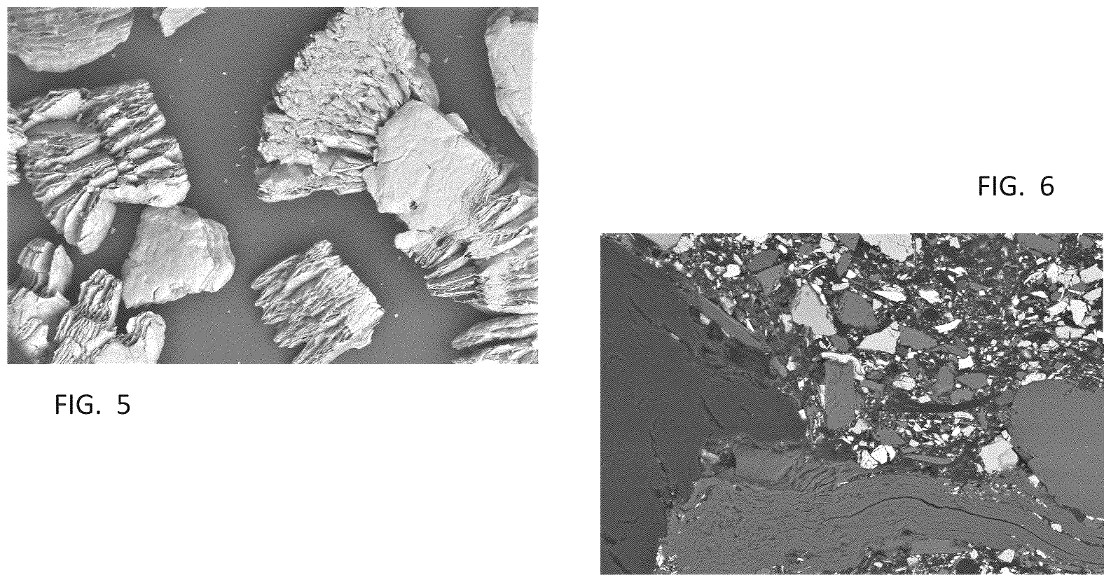

Also the choice of the right filler/s may be of high importance in the friction material composition of the present disclosure. In particular, in FIG. 5 it is shown a micrography of a raw material consisting in a preferred filler, namely Vermiculite-phyllosilicate. FIG. 6 shows the aspect of the same filler within a cured friction material composition according to the invention. Having regard to the aspect of the starting raw material, the Vermiculite-phyllosilicate has bene squeezed in elongated particles embedded in the matrix of friction material and that can impart to the cured friction material composition an higher strength.

According to a further aspect of the invention, the carbon based materials, as referred to above, may be contained in the compositions according to the present disclosure in an amount of less than 22% vol (in volume) calculated on the total volume of the composition, i.e. in a limited, or anyway restricted, amount.

According to a further aspect of the invention, the at least one metal or a mixture of metals, when present in the composition, does not consists of copper and/or of any copper alloys, except for impurities (in any case the total content of copper is to be at the most equal to, or preferably lower than 0.5% mass, i.e. by weight), and has to be anyway contained in the composition in a low amount, namely an amount of less than 7% in volume calculated on the total volume of the composition.

Also the ratios between selected pairs of component materials within the friction material composition according to the invention may be of paramount importance to achieve the goal to solve the objective technical problem as stated at the beginning of this disclosure, namely to reduce or eliminate the tendency of the final friction material to be subjected to both the phenomena of creep groan and stiction.

The ratio between the content in volume of the at least one metal or mixture of metals and of the carbon based materials is to be preferably of 1:6 and anyway within the range from 5:100 to 88:100.

In combination with the above feature, the ratio between the content in volume of the at least one metal or mixture of metals and of the at least one hard abrasives of a Mohs hardness of above 7 having a roundish-shape is to be preferably of 1:2 and anyway within the range from 11:100 to 233:100.

According to an aspect of the invention, the friction material composition of the present disclosure does not include, except for impurities or anyway in a substantial amount, any hard abrasives of a Mohs hardness of above 7 having an angular shape, as defined according to Krumbein and Sloss (1963), i.e. having particle size wherein the ratio R/S (Roundness/Sphericity) is lower than 0.6.

So, for instance, the composition according to the invention will not include as an hard abrasive silicon carbide, at least not in a substantial amount.

Here and below, for “substantial amount” is to be understood a quantity below 10% vol of the total volume of the composition.

The ratio between the content in volume of the rounded/roundish hard abrasive (of Mohs hardness of above 7) and of the soft abrasives is preferably 1:6 and anyway within the range from 8:100 to 35:100.

In combination with the above feature, the ratio between the content in volume of the lubricants with respect to the total of the abrasives (soft and hard, rounded) is preferably 1:5 and anyway within the range from 13:100 to 62:100.

The ratio between the content in volume of at the least one hard abrasives of a Mohs hardness of above 7 having a roundish-shape and the content in volume of the carbon based materials is important to be kept around 1:3 and anyway within the range from 15:100 to 113:100.

The present invention will now be better disclosed with reference to the following working examples, which are to be intended anyway as non-limitative and non-exhaustive.

The examples and comparative examples are given herein below by way of illustration, and are not intended therefore to limit the invention.

### Example 1

Two formulations were prepared, marked as “Standard” and “Innovative”, according to the table below. The “standard” formulation corresponds to a well know friction material formulation of the LS (Low Steel) category normally used to manufacture friction material blocks for brake pads of vehicles and is used herein as a “reference” material.

TABLE 1

| | Standard | Innovative |
|---|---|---|
| | formulation | formulation |
| Raw materials categories | (% Vol) | (% Vol) |
| Organics | 22 | 24 |
| hard abrasives-angular shape- | 7 | 0 |
| Mohs > 7 | | |
| hard abrasives-rounded shape- | 0 | 7 |
| Mohs > 7 | | |
| soft abrasives-Mohs < 7 | 22 | 33 |
| sulphide base lubricants | 4 | 7 |
| inorganic filler | 6 | 10 |
| carbon based materials | 30 | 14 |
| Metals | 9 | 5 |

The components shown in Table 1, which indicates values of % by volume on the total volume of the mixture/blend were uniformly mixed in a Horizontal Mixer (e.g. Loedige kind) mixer and molded in a mold under a pressure of 20 tons for 3 minutes at a temperature of 160° C., then cured for 10 minutes of heat treatment at 400° C., producing a friction material according to the invention, indicated as “Innovative”, and a reference material according to the known art and used for subsequent comparative tests, indicated as “standard”; each block of friction material so obtained is made integral with identical metal supports consisting in flat steel plates (back-plates) to form vehicle brake pads.

### Example 2

The brake pads produced in the manner described in Example 1 have been mounted on a vehicle and undergone the following tests.

### Stiction Test—Procedure 1

Bedding→100 stops 50-0 kph, 20% g
Conditioning with tap water
Parking mode with parking brake applied
Overnight parking inside.
Release parking brake, record sound (dB) level.
Repeat above steps for 10 days (except for weekends).
Sound pressure requested as lowest as possible; the sound pressure is detected in dB via an audio and acoustic handheld analyzer type XL2 of Company NTI Audio provided with a Omnidirectional, pre-polarized condenser, free field microphone, Frequency Range 5 Hz-20 kHz, Sensitivity typical at 1 KHz-27.5 dBV/Pa±2 dB (42 mV/Pa).

The results obtained are reported in the following Tables 2 and 3.

It is to be noted that 43 dB correspond to a noise level of the vehicle (car) with engine ON (i.e. correspond to the background noise). Stiction noise levels below 43 dB are therefore not perceived, because covered by background car noise. Accordingly, when no noise has been recorded, the value of (43) dB is reported in the tables.

TABLE 2
Material:
Standard formulation

| Test day | dB |
|---|---|
| day 1 | 72 |
| day 2 | 73 |
| day 3 | — |
| day 4 | — |
| day 5 | — |
| day 6 | 72 |
| day 7 | 71 |
| day 8 | 72 |
| day 9 | 73 |
| day 10 | 73 |

TABLE 3
Material:
Innovative formulation

| Test day | dB |
|---|---|
| day 1 | (43) |
| day 2 | (43) |
| day 3 | — |
| day 4 | — |
| day 5 | (43) |
| day 6 | (43) |
| day 7 | 48 |
| day 8 | 50 |
| day 9 | 55 |
| day 10 | 54 |

As it may be seen from the comparison of the values of noisiness in tables 2 and 3 above, the noise in dB resulted for Low Steel “Innovative” Formulation is much lower than that of “Standard” formulation (reference).

### Stiction Test-Procedure 2

200 stops from 80 km/h to 20 km/h at 0.3 g
Spray disc with 5% NaCl solution
Clamping force according to project parameter.
Let the car parked outside for 3 days (first and second test) and 10 days (third test)
Torque measurement with torque wrench
Result expressed in Nm

The test results are reported in the following Table 4.

TABLE 4

| | Field test | |
|---|---|---|
| Low Steel Cu-free | Vehicle test | |
| Material | (3 + 3 + 10 days, 5% Nacl) | |
| Innovative | 3 | days |
| Formulation | 40-60 | Nm |
| | 3 days + 3 days | |
| | 70-20 | Nm |
| | 3 days + 3 days + 10 days | |
| | 60-50 | Nm |
| Standard | 3 | days |
| Formulation | 80-110 | Nm |

| 3 days + 3 days | |
|---|---|
| 120-110 | Nm |
| 3 days + 3 days + 10 days | |
| 340-280 | Nm |

As shown in Table 4, stiction results for Low Steel Innovative Formulation are much lower than for Standard formulation.

### Creep Groan Vehicle Procedure-Description and Evaluation:

Bedding→40 br.—30 bar—from 100 to 50 km/h-Every 1.5 km
Stop Squeal Evaluation step 1 to 5:
Step1—Morning—After 1 night, vehicle outside parked, drive to the slope w/o braking—Slope at 12% —Engine on—[FORWARD]
Step2—Repeat step1 [BACKWARD]
Step3—Flat road
Step4—Repeat step1 after warm up at 30° C. [FORWARD]
Step5-Repeat step 2 after warm up at 30° C. [BACKWARD]
Repeat step 1-5 for 3 days.
To consider humidity RH [%] and temperature [C]
Evaluate CG (Creep Groan) considering: Intensity/Reproducibility−subjective Index min.: 4; index max.: 10.

The results obtained are reported in following Table 5.

TABLE 5

| | | LS¶ | | | LST¶ | | |
|---|---|---|---|---|---|---|---|
| | | Standard-formulation¶ | | | Innovative-formulation¶ | | |
| | | | | 5th eval. | | | 5th eval. |
| Ambiental condition | | 1st eval. | 2nd eval. | [Wet] | 1st eval. | 2th eval. | [Wet] |
| Humidity [%] | | 74 | 72 | 68 | 84 | 87 | 88 |
| Temperature [° C.] | | 17 | 14 | 15 | 10 | 12 | 14 |
| After 1 night Slope 12% Forward | index | 6 | 6 | 6 | 10 | 10 | 10 |
| After 1 night Slope 12% Reverse | | 5.5 | 6 | 5 | 10 | 10 | 10 |
| Flat - drug stop and go | | 6 | 6 | 5 | 9.5 | 10 | 10 |
| T ° C. 30 Forward | | 8.5 | 9 | 8.5 | 10 | 10 | 10 |
| T ° C. 30 Reverse | | 8.5 | 8.5 | 8 | 10 | 10 | 10 |
| Daily evaluation | | 7 | 7 | 6 | 9.9 | 10 | 10 |

| | | |
|---|---|---|
| Global evaluation | 6.8 | 10.0 |

shows a Creep Groan behavior quite better than the reference (standard) formulation and aligned to that of known NAO materials.

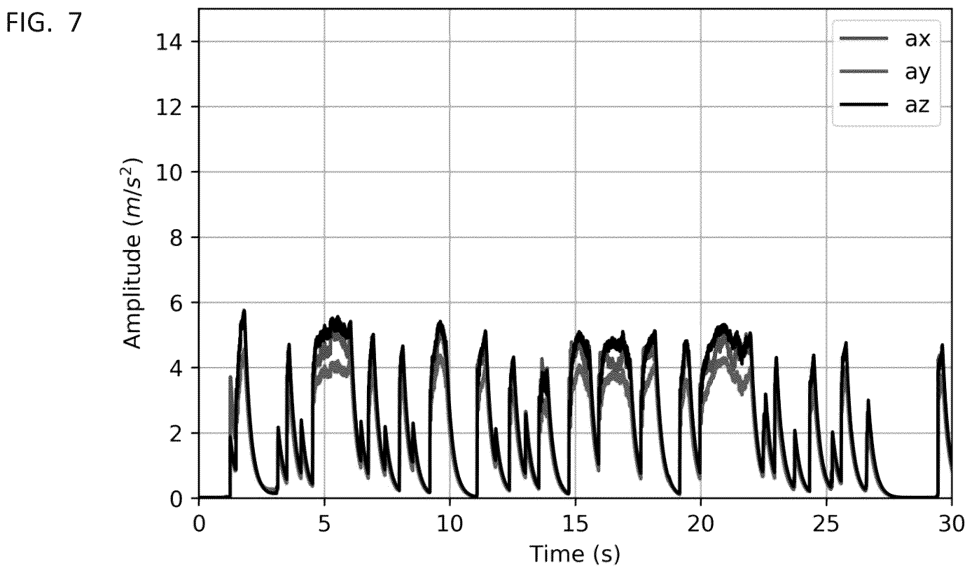

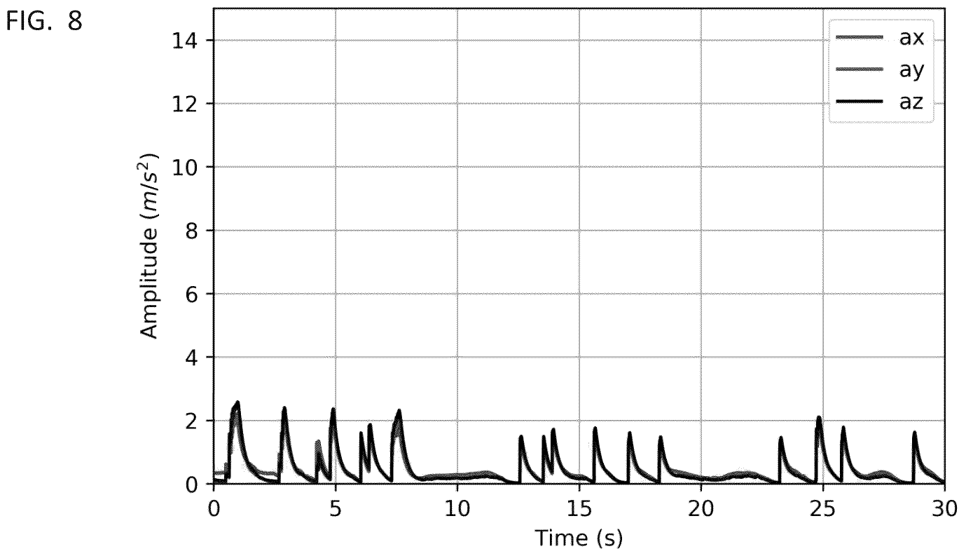

The vibration in function of time have also been measured during the brake application by a Squadriga triaxle accelerometer: Amplitude (m/s²) Vs Time(s). The results obtained are reported in FIGS. 7 and 8. FIG. 7 shows the behavior of the Reference (standard) formulation, while FIG. 8 shows the behavior of the Innovative formulation. It is clear that the amplitude and frequency of the detected vibrations is dramatically lower in the friction material composition (Innovative) according to the present invention.

### Example 3

The brake pads produced in the manner described in Example 1 have been mounted on a vehicle and undergone an Efficiency test according to AK-Master standards, including: settling braking, braking at different fluid pressures, cold braking (<50° C.), motorway simulation braking, two series of high-energy braking (FADE test) interspersed with a series of recovery braking.

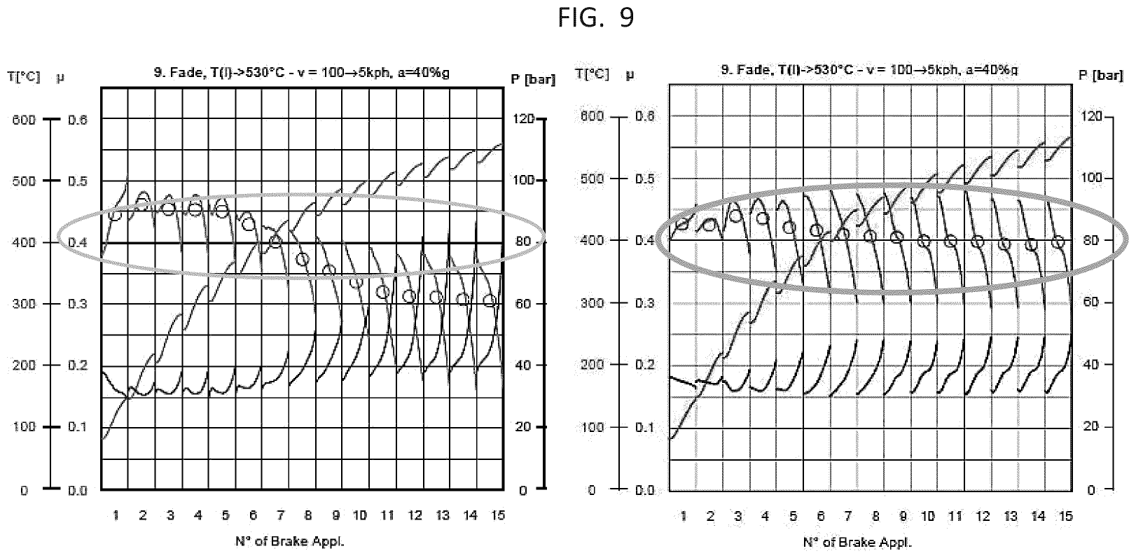

The results obtained are reported in FIG. 9, which compares the graphics relating to the FADE section of the test in the case of the standard (Reference) formulation-left side graph—and in the case of the Innovative (according to the invention) formulation-right side graph.

Of particular significance is the part encircled in both graphs. The Innovative Formulation has shown overall nominal friction level comparable to a Standard Low Steel formulation (0.41 Vs 0.44); but the Fading performances of the Innovative formulation are higher and more stable along all the fade section than those of the Standard formulation.

### Example 4

Ten formulations were prepared within the ranges given in the Table 6 below, varying in a random manner the relative quantities of the friction material components listed in table 6 itself.

TABLE 6

| | Innovative |
|---|---|
| | Ranges |
| Raw materials categories. | (% Vol) |
| Organics | 20-30 |
| hard abrasives-angular shape-Mohs > 7 | 0-3 |
| hard abrasives-rounded shape-Mohs > 7 | 3-9 |
| soft abrasives-Mohs < 7 | 26-38 |
| sulphide base lubricants | 6-18 |
| inorganic filler | 8-20 |
| carbon based materials | <22 |
| Metals | <7 |

Thereafter, corresponding friction pads were prepared using the ten different formulations of friction material composition prepared according to the content of Table 6, operating like in Example 1. Thereafter, the tests as described and reported in Examples 2 and 3 have been repeated on the new brake pads, obtaining results always comparable to those as described previously (behavior of the compositions limited to a variation 10% more or less than the Innovative composition of Example 1.

From what stated above and from the preceding working examples, it is clear that the invention also extends to a brake pad including a friction material block made of the friction material composition according the present disclosure.

Moreover, the invention also extends to a method for manufacturing brake pads for vehicles having a reduced or nil tendency to both stiction and creep groan, the method comprising the step of preparing an asbestos free friction material composition comprising, as composing materials thereof, at least one organic binder, at least one inorganic filler, at least a lubricant, at least one hard abrasive having a Mohs hardness of above 7, at least a soft abrasive having a Mohs hardness of below 7, carbon based materials and, optionally, at least one metal or a mixture of metals; and the steps of molding said friction material composition in a friction material block or layer applied on a metallic support and of curing the friction material block or layer so obtained; wherein:
i. the hard abrasives of a Mohs hardness of above 7 included in the composition consist, exclusively or almost exclusively, in hard abrasives having a roundish-shape (within the meaning clarified above);
ii. the carbon based materials included in the composition are kept in an amount of less than 22% vol (in volume) calculated on the total volume of the composition;
iii. the at least one metal or a mixture of metals included in the composition does not consist of Cu, except for impurities, and may be chosen in the group consisting in: Iron, Steel, stainless steel, Tin, Zinc, Metal alloys except than Cu alloys (unless for impurities) in powder or fiber form, Steel fibers, Stainless steel fibers, mixtures thereof; and is included in the composition in an amount of less than 7% in volume calculated on the total volume of the composition.

In the method of the present invention, the content in volume of the at least one said hard abrasives of a Mohs hardness of above 7 having a roundish-shape and the content in volume of said carbon based materials may be chosen, with reference to the total of the friction material composition, in a ratio of 1:3.

Moreover, the carbon based materials may be preferably chosen in the group consisting in: Graphite, Graphitized coke, Petroleum coke, Desulfurized petroleum coke, Carbon black, graphene, mixtures thereof.

Finally, the content in volume of the at least one metal or mixture of metals and of the carbon based materials in the friction material composition may be chosen in a ratio of 1:6; and the content in volume of the at least one metal or mixture of metals and of the at least one said hard abrasives of a Mohs hardness of above 7 having a roundish-shape in the friction material composition may be chosen in a ratio of 1:2.

### CONCLUSIONS

From the above working examples and disclosure it is clear that friction material compositions prepared according to this disclosure and in particular falling within the relative composition values given in Table 6 are quite less subject to the phenomena of both stiction and creep groan than a similar standard LS composition, while keeping braking performances comparable or even better to the standard LS compositions; creep groan behavior is moreover substantially comparable to that of the NAO friction materials without the innovative material presenting the notoriously less good braking performances of the NAO materials in comparison to the LS materials.

All the aims of the present disclosure are therefore fulfilled.

### Certain Terminology

Although certain braking devices, systems, and methods have been disclosed in the context of certain example embodiments, it will be understood by those skilled in the art that the scope of this disclosure extends beyond the specifically disclosed embodiments to other alternative embodiments and/or uses of the embodiments and certain modifications and equivalents thereof. Use with any structure is expressly within the scope of this invention. Various features and aspects of the disclosed embodiments can be combined with or substituted for one another in order to form varying modes of the assembly. The scope of this disclosure should not be limited by the particular disclosed embodiments described herein.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Unless stated otherwise, the terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. Likewise, the term “generally” as used herein represents a value, amount, or characteristic that predominantly includes or tends toward a particular value, amount, or characteristic.

This disclosure expressly contemplates that various features and aspects of the disclosed embodiments can be combined with, or substituted for, one another. Accordingly, the scope of this disclosure should not be limited by the particular disclosed embodiments described above, but should be determined only by a fair reading of the claims that follow as well as their full scope of equivalents.

1. An asbestos free friction material composition having a content of copper of 0.5% mass or less, designed to be formed as a friction block or layer to equip a braking element like a brake pad or a brake shoe, the asbestos free friction material composition comprising, as composing materials thereof:
at least one organic binder;
at least one inorganic filler;
at least a lubricant;
at least one hard abrasive having a Mohs hardness of above 7;
at least a soft abrasive having a Mohs hardness of below 7;
carbon based materials; and
at least one metal or a mixture of metals, wherein in combination:
i. the hard abrasives of a Mohs hardness of above 7 consist exclusively of hard abrasives having a roundish-shape;
ii. the carbon based materials are contained in said composition in an amount of less than 22% vol (in volume) calculated on the total volume of the composition;
iii. the said at least one metal or a mixture of metals does not consist of copper and/or of copper alloys except for impurities and is contained in said composition in an amount of less than 7% in volume calculated on the total volume of the composition.

2. The asbestos free friction material composition of claim 1, wherein
said at least one lubricant consists of a sulphide based lubricant chosen from a group consisting in the metal sulfides of Sn, Zn, Fe, Mo, and mixtures thereof; and
said sulphide based lubricant being contained in the composition in an amount comprised between 6% vol and 18% vol calculated on the total volume of the composition.

3. The asbestos free friction material composition of claim 1, wherein
the at least one soft abrasive having a Mohs hardness of below 7 is contained in the composition in an amount comprised between 26% vol and 38% vol calculated on the total volume of the composition;
said soft abrasive being preferably chosen from a group consisting in: Magnesia, Cromite, Zirconia, Magnetite, Hematite, Quartz, Zinc oxides, Tin oxides, barium sulphate, silicate, fluoride, and any mixture thereof.

4. The asbestos free friction material composition according to claim 1, wherein the hard abrasives of a Mohs hardness of above 7 having a roundish-shape include exclusively abrasive particles having a ratio R/S (Roundness/Sphericity) in the interval:
0.6≤R/S≤0.8,
where R and S are calculated according to Krumbein and Sloss (1963).

5. The asbestos free friction material composition according to claim 4, wherein the hard abrasives of a Mohs hardness of above 7 having a roundish-shape is chosen in the from a group consisting in: Alumina, Corindone, Silicon carbide, Tungsten carbide, Zirconium carbide, Zirconium silicate, Boron nitride, and any mixture thereof.

6. The asbestos free friction material composition according to claim 1, wherein
the at least one organic binder consists of anyone of the following: Phenolic resins, Epoxy resins, siliconic resins, Modified phenolic resins, melamminic resins, polymmide resins and mixtures thereof; and
the at least one organic binder is present in the composition in an amount comprised between 20% vol and 30% vol calculated on the total volume of the composition.

7. The asbestos free friction material composition according to claim 1, wherein
the at least one inorganic filler is present in the composition in an amount comprised between 8% vol and 20% vol calculated on the total volume of the composition; and
the least one inorganic filler is preferably chosen from a group consisting in: Mineral fibers, Glass fibers, rockwool, phillosilicates (mica, vermiculite, talc), Titanates, inorganic hydroxides of Ca, Mg, K, and any mixture thereof.

8. The asbestos free friction material composition according to claim 1, wherein the asbestos free friction material composition excludes, except for impurities, any hard abrasives of a Mohs hardness of above 7 having an angular shape, as defined according to Krumbein and Sloss (1963), having a particle size where the ratio R/S (Roundness/Sphericity) is lower than 0.6.

9. The asbestos free friction material composition according to claim 1, wherein a ratio between the content in volume of said rounded hard abrasive and said soft abrasives is comprised between 8:100 and 35:100 and is preferably 1:6 and, in combination, the ratio between the content in volume of the lubricants with respect to the total of the abrasives (soft and hard, rounded) is comprised between 13:100 and 62:10 and is preferably 1:5.

10. The asbestos free friction material composition according to claim 1, wherein
a ratio between the content in volume of at least one said hard abrasives of a Mohs hardness of above 7 having a roundish-shape and the content in volume of said carbon based materials is comprised between 15:100 and 113:10 and is preferably 1:3;
said carbon based materials are preferably chosen from a group consisting in: Graphite, Graphitized coke, Petroleum coke, Desulfurized petroleum coke, Carbon black, graphene, and mixtures thereof.

11. The asbestos free friction material composition according to claim 1, wherein
the asbestos free friction material composition further comprises organic fibers chosen from a group consisting in: Polyacrylic fibers, Polyaramid fibers, Aramid fibers, Cellulose fibers, and any mixture thereof; and
a content of organic fibers present in the composition is chosen as a fraction of the content of the organic binder.

12. The asbestos free friction material composition according to claim 1, wherein
the at least one metal is chosen from a group consisting in: Iron, Steel, stainless steel, Tin, Zinc, Metal alloys except than Cu alloys in powder or fiber form, Steel fibers, Stainless steel fibers;
a ratio between the content in volume of said at least one metal or mixture of metals and said carbon based materials is comprised between 5:100 and 88:10 and is preferably 1:6, and
in combination, the ratio between the content in volume of said at least one metal or mixture of metals and said at least one said hard abrasives of a Mohs hardness of above 7 having a roundish-shape is comprised between 11:100 and 233:10 and is preferably 1:2.

13. (canceled)

14. A method for manufacturing brake pads for vehicles having a reduced or nil tendency to both stiction and creep groan, the method comprising:
preparing an asbestos free friction material composition comprising, as composing materials thereof, at least one organic binder, at least one inorganic filler, at least a lubricant, at least one hard abrasive having a Mohs hardness of above 7, at least a soft abrasive having a Mohs hardness of below 7, carbon based materials and, optionally, at least one metal or a mixture of metals;
molding said friction material composition in a friction material block or layer applied on a metallic support; and
curing the friction material block or layer so obtained; wherein:
i. the hard abrasives of a Mohs hardness of above 7 included in said composition consist exclusively in hard abrasives having a roundish-shape;
ii. the carbon based materials included in said composition are kept in an amount of less than 22% vol (in volume) calculated on the total volume of the composition;
iii. the at least one metal or a mixture of metals included in the composition is chosen in the group consisting in: Iron, Steel, stainless steel, Tin, Zinc, Metal alloys except than Cu alloys in powder or fiber form, Steel fibers, Stainless steel fibers, and mixtures thereof; and is included in the said composition in an amount of less than 7% in volume calculated on the total volume of the composition.

15. The method of claim 14, wherein the content in volume of the at least one said hard abrasives of a Mohs hardness of above 7 having a roundish-shape and the content in volume of said carbon based materials are chosen in said friction material composition in a ratio comprised between 15:100 and 113:10 and is preferably of 1:3, said carbon based materials being preferably chosen in the group consisting in: Graphite, Graphitized coke, Petroleum coke, Desulfurized petroleum coke, Carbon black, graphene, mixtures thereof; and wherein the content in volume of said at least one metal or mixture of metals and said carbon based materials in said friction material composition are chosen in a ratio comprised between 5:100 and 88:100 and preferably in a ratio of 1:6, while the content in volume of said at least one metal or mixture of metals and said at least one said hard abrasives of a Mohs hardness of above 7 having a roundish-shape in said friction material composition are chosen in a ratio comprised between 11:100 and 233:100 and preferably in a ratio of 1:2.

16. A brake pad including a friction material block made of a friction material composition having a content of copper of 0.5% mass or less, designed to be formed as a friction block or layer to equip a braking element like a brake pad or a brake shoe, the asbestos free friction material composition comprising, as composing materials thereof:
at least one organic binder;
at least one inorganic filler;
at least a lubricant;
at least one hard abrasive having a Mohs hardness of above 7;
at least a soft abrasive having a Mohs hardness of below 7;
carbon based materials; and
at least one metal or a mixture of metals, wherein in combination:
i. the hard abrasives of a Mohs hardness of above 7 consist exclusively of hard abrasives having a roundish-shape;
ii. the carbon based materials are contained in said composition in an amount of less than 22% vol (in volume) calculated on the total volume of the composition;
iii. the said at least one metal or a mixture of metals does not consist of copper and/or of copper alloys except for impurities and is contained in said composition in an amount of less than 7% in volume calculated on the total volume of the composition.

17. The brake pad of claim 16, wherein
said at least one lubricant consists of a sulphide based lubricant chosen from a group consisting in the metal sulfides of Sn, Zn, Fe, Mo, and mixtures thereof;
said sulphide based lubricant being contained in the composition in an amount comprised between 6% vol and 18% vol calculated on the total volume of the composition;
the at least one soft abrasive having a Mohs hardness of below 7 is contained in the composition in an amount comprised between 26% vol and 38% vol calculated on the total volume of the composition;
said soft abrasive being preferably chosen from a group consisting in: Magnesia, Cromite, Zirconia, Magnetite, Hematite, Quartz, Zinc oxides, Tin oxides, barium sulphate, silicate, fluoride, and any mixture thereof.

18. The brake pad according to claim 16, wherein
the at least one organic binder consists of anyone of the following: Phenolic resins, Epoxy resins, siliconic resins, Modified phenolic resins, melamminic resins, polymmide resins and mixtures thereof;
the at least one organic binder is present in the composition in an amount comprised between 20% vol and 30% vol calculated on the total volume of the composition;
the at least one inorganic filler is present in the composition in an amount comprised between 8% vol and 20% vol calculated on the total volume of the composition; and
the least one inorganic filler is preferably chosen from a group consisting in: Mineral fibers, Glass fibers, rockwool, phillosilicates (mica, vermiculite, talc), Titanates, inorganic hydroxides of Ca, Mg, K, and any mixture thereof.

19. The brake pad according to claim 16, wherein
the asbestos free friction material composition excludes, except for impurities, any hard abrasives of a Mohs hardness of above 7 having an angular shape, as defined according to Krumbein and Sloss (1963), having a particle size where the ratio R/S (Roundness/Sphericity) is lower than 0.6;
a ratio between the content in volume of said rounded hard abrasive and said soft abrasives is comprised between 8:100 and 35:100 and is preferably 1:6 and, in combination, the ratio between the content in volume of the lubricants with respect to the total of the abrasives (soft and hard, rounded) is comprised between 13:100 and 62:10 and is preferably 1:5.

20. The brake pad according to claim 16, wherein
the asbestos free friction material composition further comprises organic fibers chosen from a group consisting in: Polyacrylic fibers, Polyaramid fibers, Aramid fibers, Cellulose fibers, and any mixture thereof; and
a content of organic fibers present in the composition is chosen as a fraction of the content of the organic binder.
